(19) United States
(12) Patent Application Publication
(10) Pub. No.: US 2003/0086591 A1
(43) Pub. Date: May 8, 2003

(54) Identity card and tracking system

(76) Inventor: Rudy Simon, Dexter, ME (US)

Correspondence Address: BOHAN, MATHERS & ASSOCIATES, LLC, PO BOX 17707, PORTLAND, ME, 04112-8707, US

(21) Appl. No.: 10/198,342

(22) Filed: Jul. 18, 2002

Related U.S. Application Data
(60) Provisional application No. 60/344,833, filed on Nov. 7, 2001.

(51) Int. Cl. G06K 9/00

(52) U.S. Cl. 382/115

(57) ABSTRACT

A machine-readable identity card and tracking system that includes the identity card, a card scanner adapted to read the card, a central registry, and a telecommunications link between the card scanner and the central registry. Data pertaining to the card bearer is stored on the card and in the central registry. The data include biographic data, biometric data, such as a facial image, or a holographically distorted, machine-readable image of a biometric feature of the card bearer, and genetic data, such as a DNA fingerprint. The card also includes an access control function linked with a biometric feature of the card bearer. The card is tamper-proof, provides reliable verification of the identity of the person presenting the card and card validation.

### BACKGROUND INFORMATION

### FIELD OF THE INVENTION

The invention relates to the field of personal identification. More particularly, the invention relates to the field of personal identity cards that are tamper-proof and machine readable.

Effective means of providing accurate identification of a user of services and a means of verifying the identification have long been sought. With the advent of automated banking services and communication services, it has become even more critical that a simple, tamper-proof means of identification be provided. A well-known example of conventional identification means is the credit card that carries, encoded in a magnetic strip or in a small chip on the card, data that identifies the card owner and the corresponding account number.

This type of card is also often used for automated banking services, and for such applications, the card bearer is required to verify his or her identification by entering a Personal Identification Number (PIN) which, ideally, is known only to and memorized by the card owner. The difficulty with relying on a PIN for verification is that the card owner must memorize and remember the PIN for each application and take precautions that it does not get into the hands of unauthorized persons.

Providing an identification means that is tamper-proof and cannot be used to perpetrate identity theft is a further difficulty with the known cards. For example, once the visible, public information on the credit card is known to a third party, that party can use the information to effect purchases via the Internet, over the phone, or via mail order.

Today, there is also a wide-felt need for authorized agencies or entities to have the ability to either track the usage of the card or, at least, to review the usage history of the card. The means for providing usage history are known. For example, banks provide monthly billing statements for credit cards that itemize each use of the card during the billing period. Each entry for an item includes a code that identifies the point of use of the card. Use of a general-purpose ID card that is used to verify identity in a wide variety of applications, such as money transactions, travel, etc., and systematic recording of data indicating the type of activity for which the card is used and the geographic location would provide the basis for a comprehensive tracking system that would provide important information to law-enforcement or national security agencies, for example.

What is needed, therefore, is) an ID card that is tamper-proof, shields information from unauthorized users, and provides a means of unambiguous identification unique to the legitimate card bearer, as well as a means for reliable verification that the user is the legitimate card bearer. What is further needed is such an ID card that provides the basis for tracking the activities and movements of persons for law-enforcement or security purposes.

### BRIEF SUMMARY OF THE INVENTION

For the reasons cited above, it is an object of the present invention to provide an identity card (ID Card) that carries unambiguous identification of the legitimate card bearer and prevents identity theft. It is a further object to provide such an ID card that is machine readable, tamper-proof, and durable. It is a yet further object to provide such an ID Card that includes several types of identification information, such as biographic and biometric information. It is a still further object to provide such an ID Card that provides useful data for tracking and security purposes.

The objects are achieved by providing a multiple-tier identity card that bears machine-readable, encrypted digital data and images. Includable in the encrypted digital data are central registry data, biographic data, and biometric data. Biometric data, as the term is used herein, include any unique biological or physical characteristics or features of an individual. Such features and characteristics include, but are not limited to, a fingerprint, a facial image, a retinal image, a voice print, a unique DNA sequence (also called a DNA fingerprint), a handprint, and/or dental or medical data. Ideally, the data are digitally encoded and encrypted, and readable only with an appropriate scanning or reading device.

The following discussion of the card according to the invention refers to a “multiple-tier” card, the term “tier” referring to various levels of information that can be accessed by persons or entities having authorized access to particular types of information. Generally, the first tier includes data of the lowest privacy level, such as biographic data; the second tier has data requiring a higher level of protection against invasion of privacy, for example national security data; and the third tier has data that demands the greatest level of privacy protection, for example, biometric data. Central registry data include data such as social security number, voter registration, and driver's license information; biographic data include date and birthplace of the card bearer; and biometric data include the type of biometric data described in the preceding paragraph, most typically a fingerprint and/or an encoded DNA sequence that is unique to the card bearer.

The ID card can serve as a conventional identification card. It may, or may not, have a picture of the legitimate card bearer, but it does contain information that will unambiguously identify the card bearer. For example, conventional identification cards rely on a picture of the card bearer plus other biographic data, such as the birth date, to provide a means of determining if the person presenting the card is authorized to receive the desired access, goods, or services. The pictures on identification cards are notoriously bad and it is often difficult for control personnel to determine that the card bearer and the person whose image is on the identification card are one and the same. The ID card according to the invention provides a means of verifying the identity of the card bearer as being the legitimate bearer of the card, by providing biometric data that can be read on the spot and compared with biometric data taken contemporaneously from the card bearer. If the identity of the card bearer is questioned, biometric data may be obtained momentarily from the card bearer and compared with the biometric data incorporated into the ID card. For example, the card bearer may be required to press a fingerprint scanner button, which causes a scanner to generate an image of the fingerprint, which can then be compared, manually or electronically, with the fingerprint stored on the ID card.

The ID card with the national, biographic, and biometric data serves as a tool for identification control, that is, it serves to verify the identity of the card bearer, and also, provides means for verifying the validity of the card itself. Because it is tamper-proof and contains within it the means for confirming the identification of the person and confirming the validity of the card, the ID card provides more reliable control of access to locations, goods, or services that are subject to access restrictions.

In some cases, it may be necessary to validate the ID card itself. The biometric data provides the means for validating the card by allowing a comparison of biometric data stored in a database of a central registry with biometric data taken from the person presenting the ID card. For example, a national agency may issue the card and store the national, biographic, and biometric data that is encoded on the card in a central data registry. If biometric sample that is contemporaneously taken from the card bearer and then compared with stored data, that is, with the data encoded on the card or stored in the database, and found to match the stored data, then identity of the card bearer and the validity of the card have been confirmed.

According to the invention, biometric data are encoded in machine-readable format and incorporated in the ID card such that it is machine-readable. If the biometric data are collected and stored in an electronic database before the ID card is issued, the data can then ideally be downloaded from the database and incorporated onto the ID card at the time the card is being issued. So, for example, if the biometric data are to include a DNA sequence, a DNA sample is taken from the intended bearer of the ID card, analyzed, and the results stored in a database maintained at a central registry. Since the card bearer carries his or her genetic information at all times, it is a relatively simple matter to obtain a verification tissue sample containing DNA from the card bearer at any time and location. For example, a scrape of the inner cheek of the card bearer with a swab provides sufficient tissue to obtain a sample of DNA for analysis, to provide data which can be verified against the legitimate card bearer's genetic data, either by reading the data encoded on the ID card with an appropriate card reader, or by comparing it with data that is stored at the central data registry.

The card “reader”, also called a scanner, is provided locally at a site where identification control and verification is required and is linkable with the database in the central registry by conventional telecommunications means so that data (national, biographic, biometric) from the ID card can be exchanged or verified with data stored in the database.

There are several known methods of analyzing the DNA of a person and determining a unique DNA sequence, also referred to hereinafter as a genetic fingerprint or a DNA fingerprint, that can then be used to identify that person. Genetic identification is highly reliable, providing extremely high certainty for a positive match between evidence collected from a first source and a second source, with, of course, the exception of identical twins, who have identical DNA. There are many suitable, different methods of determining a DNA fingerprint, most of which use nuclear DNA, but also some of which use mitochondrial DNA. The most common method of DNA analysis used today is the Short Tandem Repeat (STR) method, which analyzes the tandem repeats at certain loci on the DNA strand. The FBI, for example, is building an electronically-readable library of DNA fingerprints of criminals who have committed certain types of crimes and, to this end, has designated 13 core STR loci as the basis for DNA fingerprinting. STRs are highly polymorphic, i.e., they vary widely in the population, and analyzing more than one of the core STR loci from the DNA of a person will return a highly reliable and individual DNA fingerprint of that person. The FBI is now in the process of collecting DNA from certain persons, anaylizing the genetic information at one or more of the 13 STR loci, and storing this data in electronically-readable form in its nationwide Combined DNA Index System (CODIS) database. The information in this database is made available to law-enforcement agencies around the country, so that they can compare DNA samples taken from a person at a local venue with DNA data stored in the database. Fact sheets with information for each of the 13 loci have been widely published in journals and on the Internet. Several kits are available on the market that provide simple, easily applicable tools for analyzing the DNA at these loci and methods using time-of-flight mass spectrometry are being developed that provide a rapid, accurate, and cost-effective means of DNA analysis.

A variety of safety measures to ensure proper verification of the DNA information are applicable to the identity card of the present invention. For example, rather than using the 13 loci mentioned above, it may be desirable to use randomized DNA sequences to reduce the likelihood of a mis-reading of the sequence. The randomization algorithm to determine from which section of the genome to extract the DNA sequence that is to be stored in the central registry and incorporated on the ID card is then also stored in the central registry and provided as needed when the information on the ID card is being verified.

Once the DNA has been analyzed and a DNA fingerprint determined, the data are digitized and incorporated on the ID card in machine-readable form. Ideally, the data are encrypted for reasons of privacy and security. Any of the available means of encrypting DNA information can be used for the identity card. To confirm the identity of the bearer of an ID card according to the invention, the ID card is inserted into a local reader that reads the encoded DNA information on the card, compares it with the information stored at the central registry, and indicates validation or non-validation of the information. In most applications, it is not necessary that the DNA information be decoded on-site, which ensures greater privacy for the card bearer. In some instances, it may be necessary that the digital information be read and decoded on-site. This is particularly advantageous in locations where a verification sample of DNA taken from the card bearer's body can also be analyzed and compared on-site with the DNA information stored in the central registry.

Depending on the degree of security required, genetic or other type of information relating to one or more relatives can also be provided on the ID card. For example, a DNA sequence of the card bearer's father and mother, or father and maternal grandfather, mother and paternal grandmother, mother and son, etc. can be encoded on the ID card.

The ID card according to the invention can, of course, contain biometric data other than, or in addition to, the DNA information. For example, a retinal image, hand print, or facial image can be digitized and incorporated into the ID card in machine-readable form and stored in the central data registry.

The ID card may also include one or more visual images, at least one of which is machine-readable only. The card is made of a composite material that is rugged and durable, is waterproof, shred resistant, and generally resistant to environmental conditions. The composite material may include a ceramic material that is heat resistant and fireproof.

The data contained on the ID card are stored in a remote central data registry that is accessible via a network of card scanners that are located at local facilities throughout a geographic area. When the ID card is scanned, the visual images and the central registry data and biographical data are decrypted and presented to the scanner operator. Ideally, the scanners are located in sites such as police stations, police patrol vehicles, security checkpoints for airports, federal buildings, etc., and at any facility where the identities of persons entering and/or using the facility must be controlled or tracked.

Data may be collected by many and various data collection agencies and forwarded to the central data registry. For example, municipal agencies that issue birth certificates, death certificates, marriage certificates, etc., state and federal agencies that issue social security numbers, drivers' licenses, identification numbers, etc., may be required to forward data pertaining to such issued certificates to the central data registry on a regular basis. Educational institutions may also forward information about diplomas, certificates, college degrees, etc. to this data registry and educational information may be provided on the ID card.

The ID card according to the invention is scanned by a reader or scanning device adapted to read the encrypted data and holographically distorted images on the card. Such scanning devices exist today and require only that they be adapted to read the particular type of encrypted data and holographic images on the ID card according to the present invention.

The tracking system according to the invention is based on a wide-spread use of the ID card and availability of adapted card scanners. Each time the ID card is scanned into a scanner, the location of the scanner and perhaps other information are stored in the central data registry. In this way, the ID card not only identifies the legitimate card bearer, but also provides historical information as to the activities and whereabouts of the card bearer. The tracking system further encompasses the use of other scanning devices, such as facial thermal scanning cameras, retinal imagers, hand-print scanners, and other devices that detect bio-physiological characteristics such as pulse, body temperature, perspiration, rapid eye movement, and other indicators of increased tension. Particularly at such facilities such as airports, mass transportation terminals, sports stadiums, etc., users may be required to have their ID card scanned and to walk past a thermal scanning camera.

### DETAILED DESCRIPTION OF THE DRAWINGS

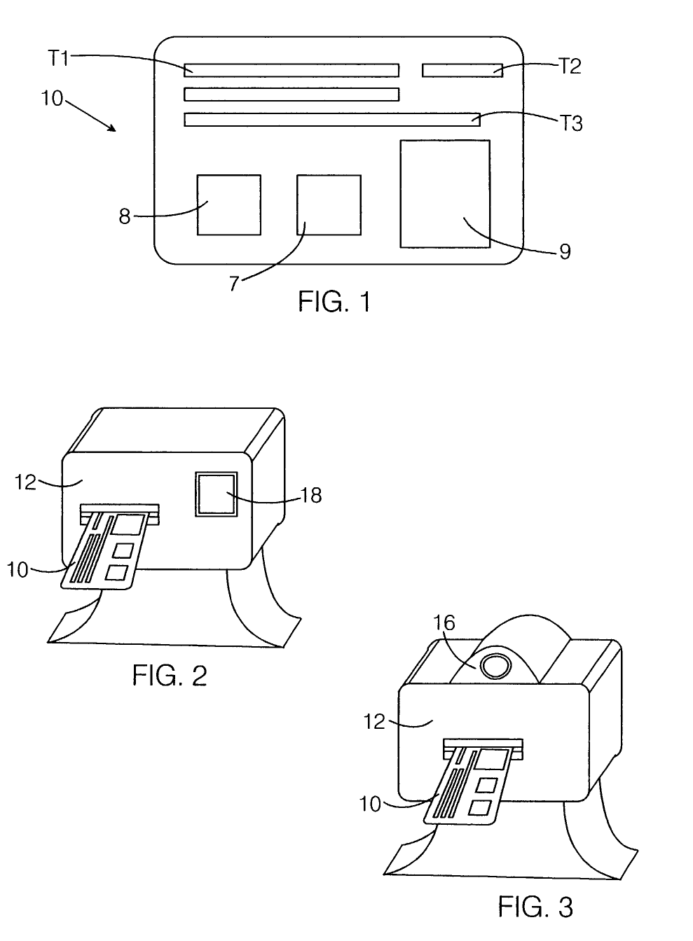

FIG. 1 is a schematic illustration of the Preferred Embodiment of the ID card according to the present invention.

FIG. 2 is a schematic illustration of the ID card of FIG. 1 inserted into a card scanner equipped with a biometric sensor.

FIG. 3 is a schematic illustration of the ID card of FIG. 1 inserted into a card scanner equipped with a retinal image scanner.

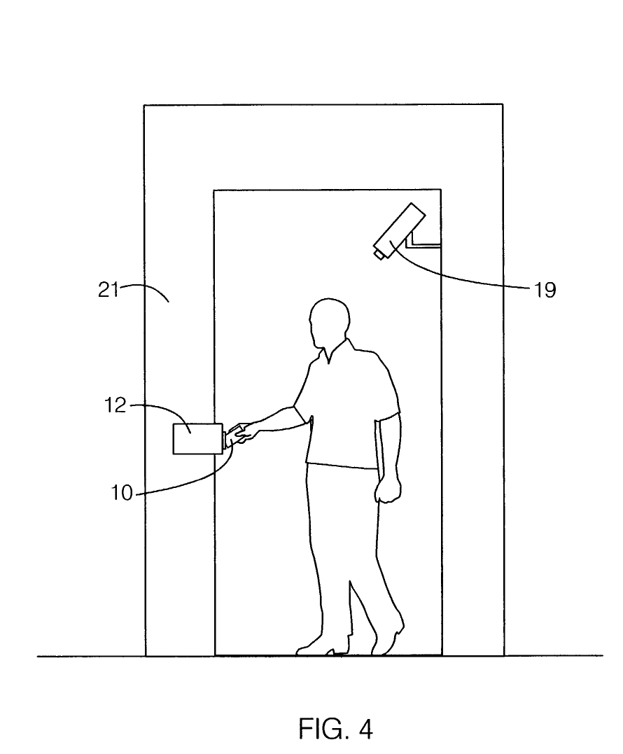

FIG. 4 is a schematic illustration of a security system according to the present invention, using the ID card of FIG. 1, a card scanner, and a facial thermal scanner.

### DETAILED DESCRIPTION OF THE INVENTION

FIG. 1 is a schematic illustration of the Preferred Embodiment of the ID card 10 according to the invention. The ID card 10 contains three tiers of information: biographic information T1, central registry information T2, and biometric information T3, as well as an additional biometric feature 8 of the legitimate card bearer, which, in the Preferred Embodiment, is a holographically distorted facial image 9. The central registry information includes at least a social security number, the biographic information at least the date and place of birth of the legitimate card bearer, and the biometric information at least a DNA sequence from the legitimate card bearer's genome. These three tiers of information may be incorporated into a single data storage device 7 that is embedded in the ID card 10, or be provided in machine-readable form in separate access areas on the card as shown. In the Preferred Embodiment, the data storage device 7 is a programmable microchip that is programmed when the ID card 10 is issued. The DNA information, once programmed, cannot be re-programmed. Other information may or may not be re-programmable, depending on whether the ID card 10 is constructed as a once-only programmable card and is replaced with a new one when some of the information is changed, or whether the card is constructed as a renewable card, wherein changeable information, such as name, address, perhaps an expiration date, can be updated on the data storage device 7. The data storage device 7 contains one or more card access control functions to ensure that the authorized card bearer is presenting the ID card 10. In the Preferred Embodiment, the data storage device 7 contains several general access control functions that control access to all or only portions of the information contained on the ID card 10.

One of the access control functions is a card validation function that requires a comparison of a biometric feature of the legitimate card bearer, such as a fingerprint or a retinal image, that is stored in the microchip with a contemporaneously scanned biometric feature of the person presenting the ID card 10. For example, if the data storage device 7 contains fingerprint information of the right index finger of the legitimate card bearer, the person presenting the ID card 10 is required to insert the card into a scanner 12 that is adapted to read the ID card 10 and to press a fingerprint detection sensor 18, shown in FIG. 2, with the right index finger. The scanner 12 will compare the fingerprint that is scanned by the sensor with the fingerprint data on the data storage device 7 and, depending on whether there is a match, allow or bar access to the goods or services, or entry to the specific location or facility requested by the person presenting the ID card 10. Similarly, if the biometric feature is a retinal image, a camera 16 attached to the scanner 12, as shown in FIG. 3, will capture an image of the retina of the person presenting the ID card 10 and compare it with the retinal image data stored on the data storage device 7.

When the ID card 10 is inserted into a card scanner 12 that is adapted to read the ID card 10 according to the invention, it will read the holographically distorted facial image 9 and display the image undistorted on a display screen attached to the card scanner 12. Thus, if the image is a facial image, the person operating the card scanner 12 is able to see the facial image in recognizable form and compare it with that of the person presenting the ID card 10.

These types of control constitute first level security steps that ensure that the legitimate card bearer is presenting or using the ID card 10. Higher level security steps may require that additional codes or passwords be entered into the scanner 12 in order to access information on the card.

The scope of the invention also encompasses a security system that includes the ID card 10 used in conjunction with an information tracking system. Each time the ID card 10 is used, the scanner sends geographical location information to the central registry, which records and stores the data and compiles a history file of the card bearer that shows the uses to which the card has been put, and where. Based on evaluation criteria deposited with the central registry, the central registry evaluates the history of the card bearer when that particular file is activated by incoming data and generates a warning if certain criteria are met. The warning may be sent to the control person at the scanner 12.

As an additional security device, bio-physiological scanners that record pulse rate, skin moisture, etc., are used in areas of high security, such as at airports, and at access gates for military facilities, power plants, etc., in conjunction with the ID card 10 and card scanner 12 for identity control and for screening for persons under unusual stress. There is scientific evidence that a person under stress exhibits detectable physiological signals, such as an elevated facial skin temperature, flushing on the face and neck, elevated rate of perspiration on the hands, rapid eye motion, and/or an accelerated pulse and heart rate.

FIG. 4 is illustrates schematically a security system using the ID card 10 and a bio-physiological scanner 19 according to the present invention at a control station 21. The security system simultaneously verifies the identity of the person passing the control station and checks for a particular bio-physiological indication of stress. By way of example, only, FIG. 4 shows a person passing the control station 21 and inserting the ID card 10 into the card scanner 12. At the same time, the bio-physiological scanner 19 scans the face of the person for one or more stress indicators, such as flushing, a raised body temperature, perspiration, or rapid blinking of the eyes. The data picked up by the bio-physiological scanner 19 is linked to the data of the bearer of the ID card 10 by any number of known means, such as by direct coupling or a telecommunications link with the card scanner 12.

The embodiments mentioned herein are merely illustrative of the present invention. It should be understood that variations in construction and processing of the present invention may be contemplated in view of the following claims without straying from the intended scope and field of the invention herein disclosed.

What is claimed is:

1. An identity card that is readable by a card scanner adapted to read said identity card, said identity card comprising:
a card substrate;
card bearer data; and
a card access control function;
wherein said card bearer data is machine-readably encoded on said card substrate, said card bearer data including biographic data and biometric data of a card bearer; and
wherein said card access control function is initiatable by said card scanner.

2. The identity card of claim 1, wherein said biometric data include a DNA sequence of said card bearer.

3. The identity card of claim 1, wherein said card bearer has a first biometric feature that is readily scannable by said card scanner;
wherein a first image of said first biometric feature is machine-readably stored in said data storage device; and
wherein said card access control function includes a comparison of said first image of said first biometric feature and a second image of said first biometric feature that is scanned by said card scanner.

4. The identity card of claim 3, wherein said first biometric feature is a feature from the group consisting of fingerprint, thumbprint, footprint, DNA fingerprint, retinal image, facial image, and ear image.

5. The identity card of claim 3 further comprising a distorted image of a second biometric feature that is readable by said card scanner and undiscernible to a person viewing said identity card without said card scanner.

6. The identity card of claim 5, wherein said second biometric feature is a facial image.

7. The identity card of claim 5, wherein said image is holographically distore

8. The identity card of claim 1, wherein said card substrate includes a substrate layer made of a fire-resistant material.

9. The identity card of claim 1, further comprising a programmable data storage device, wherein biometric data are stored on said data storage device.

10. The identity card of claim 1, wherein said programmable data storage device includes a first storage device that is a once-only programmable device and said biometric data is stored in said once-only programmable device.

11. The identity card of claim 1, wherein said programmable data storage device includes a second storage device that is a reprogrammable storage device and said card bearer data, other than said biometric data, is stored in said reprogrammable storage device.

12. A tracking system comprising:
said identity card of claim 1;
a central data registry, wherein said card bearer data are stored in said central data registry; and
a telecommunications means for linking said card scanner to said central data registry.

13. The tracking system of claim 12 further comprising usage data, wherein said card scanner includes a plurality of card scanners placed at a plurality of geographic locations, wherein usage data includes time, geographic location, and type of activity relating to a use of said identity card, and wherein, when said identity card is read by said card scanner, said usage data is transmitted to said central data registry.

14. A security system comprising a security checkpoint that includes said tracking system of claim 12 and a bio-physiological scanner adapted to detect one or more bio-physiological stress indicators exhibited by a person, wherein said card scanner provided at said security checkpoint and said bio-physiological scanner is linked with said card scanner, and wherein, when said identity card is read by said card scanner, said bio-physiological scanner is activated and links data relating to said one or more of said bio-physiological stress indicators of said person with said card bearer data.
